(19) United States
(12) Patent Application Publication
(10) Pub. No.: US 2019/0269288 A1
(43) Pub. Date: Sep. 5, 2019

(54) Mites-removing Cleaning Brush for Automobile

(71) Applicant: Hao Tong, Taizhou (CN)

(72) Inventor: Hao Tong, Taizhou (CN)

(21) Appl. No.: 16/414,753

(22) Filed: May 16, 2019

(30) Foreign Application Priority Data
Feb. 25, 2019 (CN) 201910137802X

(51) Int. Cl. A47L 7/00; B60S 3/00; A47L 5/26; A47L 9/04

(52) U.S. Cl. CPC A47L 7/0066; B60S 3/008; A47L 9/0433; A47L 7/0076; A47L 5/26

(57) ABSTRACT

This invention discloses a mites-removing cleaning brush for automobile including a cover; an extension component connected with a first end face of the cover, wherein the extension component is used when a human arm cannot extend into a certain area; a transmission cavity arranged in the cover; a power linkage component is arranged in the transmission cavity, wherein the extension component is controlled by the power linkage component; a collection groove arranged in the cover. The present invention has a simple structure, and realizes efficient adsorption by knocking which is different from conventional cleaning modes. In addition, films are additionally arranged to isolate vibrated mites from the cleaned member, which prevent the mites from falling into the cleaned member again, so problems of the member to be cleaned not being completely cleaned after repeated cleaning are avoided.

### CROSS-REFERENCES TO RELATED APPLICATIONS

The present application claims priority from Chinese application No.201910137802X filed on 2019 Feb. 25 which is hereby incorporated by reference in its entirety.

### TECHNICAL FIELD

The present invention relates to the technical field of cleaning supplies, in particular to a mites-removing cleaning brush for automobile.

### BACKGROUND OF THE INVENTION

After a vehicle is used for a long time, ash falls on surfaces in the vehicle and mites can be accumulated which will cause injury to the respiratory tract of human body, so that safety of passengers can be affected. However, traditional method by cleaning the vehicle periodically with a brush does not work with mites. Therefore, it is necessary to design a device capable of effectively removing dust and mites from the interior of a vehicle.

### BRIEF SUMMARY OF THE INVENTION

The aim of the invention is to provide a mites-removing cleaning brush for automobile so as to overcome the problems existing in the prior art.

According to embodiments of the present invention, a mites-removing cleaning brush for automobile comprises a cover; an extension component connected with a first end face of the cover, wherein the extension component is used when a human arm cannot extend into a certain area; a transmission cavity arranged in the cover; a power linkage component is arranged in the transmission cavity, wherein the extension component is controlled by the power linkage component; a collection groove in a lower end of the transmission cavity arranged in the cover; a detachable suction component rotatably connected with a top inner wall of the collection groove; limiting sliding chutes, which is located on two ends of the detachable suction component, symmetrically arranged on and communicated with the top inner wall of the collection groove; containing claw components slidably connected with and arranged in the limiting sliding chutes; vibration switch components, which are symmetric and located in the limiting sliding chutes, slidably connected with the top inner wall of the collection groove; vibration components symmetrically arranged on the top inner wall of the collection groove, wherein each of the vibration components is located on one side of a respective one of the vibration switch components.

Preferably, the power linkage component comprises a drive shaft at an outer side of a first end of the transmission cavity, wherein a first tail end the drive shaft is provided with a left coupling, and cams are symmetrically arranged on the drive shaft, wherein translation blocks which are symmetric are in threaded connection with the drive shaft, wherein the translation blocks are provided with slideways, and a driving bevel gear is arranged on the drive shaft, and an electric motor is embedded in a top inner wall of the transmission cavity, wherein a lower tail end of the electric motor is in power connection with a transmission shaft extending up and down, wherein the transmission shaft is provided with an upper bevel gear meshed with the driving bevel gear.

Preferably, the detachable suction component comprises a driven shaft rotatably connected to the top inner wall of the collection groove, wherein the driven shaft is provided with a driven bevel gear meshed with the driving bevel gear, and a lower tail end of the driven shaft is provided with a turbine located in the collection groove, wherein the driven shaft is provided with a clamping groove located on an upper side of the turbine, and a dust collecting pipe is arranged in the collection groove, wherein a dust collection cavity which is intercommunicated is arranged in the dust collecting pipe, wherein clamping rods are symmetrically arranged on and in threaded connection with the dust collection cavity, wherein the clamping rods are connected with abutted against the clamping groove, and turnable handles are arranged on first sides of the clamping rods, and a filter screen is fixedly connected with and arranged in the dust collection cavity, wherein a convey pipe which is located at a lower end of the filter screen and communicated with an external space is arranged in the dust collection cavity, and track blocks symmetrically and fixedly arranged on two end faces of the dust collection cavity; wherein the containing claw components comprise pick-up rods in the limiting sliding chutes, wherein return springs are connected with and arranged between the pick-up rods and the limiting sliding chutes, and upper tail ends of the pick-up rods are fixedly connected to suspension plates which are slidably connected to the slideways, and lower tail ends of the pick-up rods are connected to lower pressing plates, and extrusion grooves are arranged on the pick-up rods, wherein lifting blocks are arranged in and slidably connected with the extrusion grooves, wherein compression springs are connected with and arranged between lower sides of the lifting blocks and bottom inner walls of the extrusion grooves, and inner sides of the lifting blocks are fixedly connected with lifting rods abutted against the track blocks, wherein lower ends of the lifting rods are fixedly connected to upper pressing plates.

Preferably, the vibration switch components comprise inclined sliding blocks in the collection groove, wherein pull boxes are symmetrically arranged on the inclined sliding blocks, and abutting wheels are arranged on sides, close to the detachable suction component, of the pulling boxes, and the pull boxes are internally provided with limiting cavities, wherein top inner walls of the limiting cavities are provided with and communicated with sliding chutes, wherein sliding rods extending up and down into the transmission cavity are arranged on and slidably connected with the sliding chutes, wherein the sliding rods are slidably connected to a bottom inner wall of the transmission cavity, and restrain springs are connected with and arranged between the sliding rods and the sliding chutes, and lower ends of the sliding rods are provided with limiting plates which are located in and slidably connected with the limiting cavities, and upper ends of the sliding rods are fixedly connected with abutting plates which are configured to abut against the cams, wherein stop springs are connected with and arranged between lower sides of the abutting plates and the bottom inner wall of the transmission cavity; wherein the vibration components comprise tracks connected with the collection groove, wherein extension plates are connected with the sides, away from the detachable suction component, of the tracks, wherein power storage springs are arranged between the extension plates and the collection groove, and lower tail ends of the lower end of the extension plates are fixedly connected to vibration blocks, wherein a film-making component is arranged in one of the vibration blocks at a first side, and rotating rods which are configured to abut against the abutting wheels are rotatably connected to sides, away from the detachable suction component, of the extension plates, wherein restrain plates on on upper ends of the rotating rods are fixedly connected with the extension plates, and tension springs are connected with and arranged between upper sides of the rotating rods and lower sides of the restrain plates.

Preferably, the film-making component comprises an open groove arranged in one of the vibration blocks, and a hidden groove is arranged in the one of the vibration blocks, wherein a top inner wall of the hidden groove is connected with a tandem shaft, wherein a lower end of the tandem shaft is connected to a contact plate, wherein a limiting spring is connected with and arranged between an upper side of the contact plate and the top inner wall of the hidden groove, and an upper tail end of the tandem shaft is provided with a tandem bevel gear located in the open groove, and a worm located at a lower end of the tandem bevel gear is arranged on the tandem shaft, and a motor is embedded in a first inner wall of the open groove, wherein a first end of the motor is in power connection with an output shaft, wherein the output shaft is provided with a reversing bevel gear which is configured to mesh with the tandem bevel gear, and a fan wheel is arranged on the output shaft, and a fixed-point shaft is arranged in and rotatably connected to the open groove, wherein the fixed-point shaft is provided with a worm gear connected with the worm, and the fixed-point shaft is provided with a film roller located at one end of the worm gear; wherein the extension component comprises a tandem frame connected with the first end face of the cover, wherein a threaded shaft is connected with the tandem frame, wherein the threaded shaft is connected to a right coupling which is configured to abut against the left coupling, wherein a slide cavity is arranged in the right coupling, and an extension block located on a first side of the tandem frame is in threaded connection with the threaded shaft, wherein a handle is rotatably connected to a first end face of the extension block, and a push rod located at an upper end of the threaded shaft is slidably connected to the tandem frame, wherein the push rod extends into and is slidably connected to the slide cavity.

The benefits of the invention are as follows:

The present invention has a simple structure and is convenient to operate. Mites and dust adsorbed can be sufficiently removed from the member to be clean in the form of knocking and vibrating. And in this way, the cleaning quality is improved compared with traditional brush-type cleaning method.

### BRIEF DESCRIPTION OF THE DRAWINGS

For better explanation, the present invention will be detailedly described by embodiments and drawings below.

FIG. 1 is the overall schematic structural diagram of the mites-removing cleaning brush for automobile in this invention.

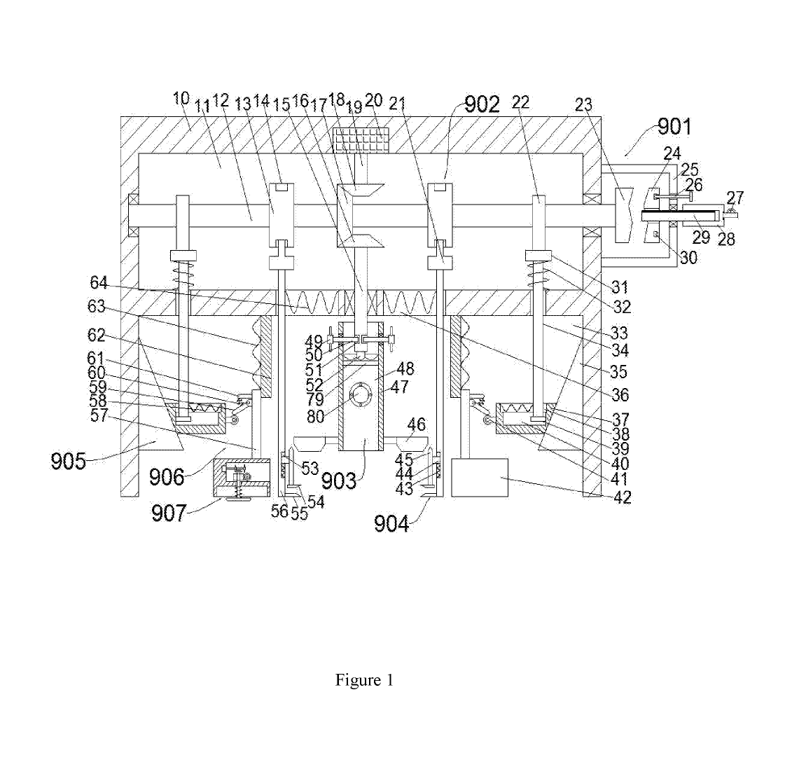

FIG. 2 is the schematic structural diagram of the film-making component in FIG. 1.

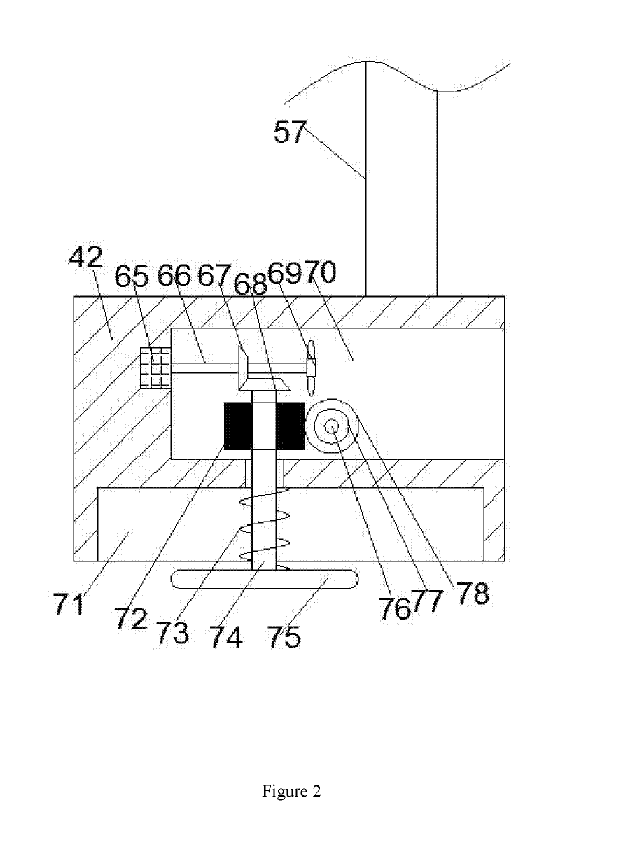

### DETAILED DESCRIPTION OF THE INVENTION

According to embodiments of the present invention, a mites-removing cleaning brush for automobile comprises a cover 10; an extension component 901 connected with a first end face of the cover 10, wherein the extension component 901 is used when a human arm cannot extend into a certain area; a transmission cavity 11 arranged in the cover 10; a power linkage component 902 is arranged in the transmission cavity 11, wherein the extension component 901 is controlled by the power linkage component 902; a collection groove 33 in a lower end of the transmission cavity 11 arranged in the cover 10; a detachable suction component 903 rotatably connected with a top inner wall of the collection groove 33; limiting sliding chutes 36, which is located on two ends of the detachable suction component 903, symmetrically arranged on and communicated with the top inner wall of the collection groove 33; containing claw components 904 slidably connected with and arranged in the limiting sliding chutes 36; vibration switch components 905, which are symmetric and located in the limiting sliding chutes 36, slidably connected with the top inner wall of the collection groove 33; vibration components 906 symmetrically arranged on the top inner wall of the collection groove 33, wherein each of the vibration components 906 is located on one side of a respective one of the vibration switch components 905.

Beneficially, the power linkage component 902 comprises a drive shaft 12 at an outer side of a first end of the transmission cavity 11, wherein a first tail end the drive shaft 12 is provided with a left coupling 23, and cams 22 are symmetrically arranged on the drive shaft 12, wherein translation blocks 13 which are symmetric are in threaded connection with the drive shaft 12, wherein the translation blocks 13 are provided with slideways 14, and a driving bevel gear 17 is arranged on the drive shaft 12, and an electric motor 20 is embedded in a top inner wall of the transmission cavity 11, wherein a lower tail end of the electric motor 20 is in power connection with a transmission shaft 19 extending up and down, wherein the transmission shaft 19 is provided with an upper bevel gear 18 meshed with the driving bevel gear 17.

Beneficially, the detachable suction component 903 comprises a driven shaft 15 rotatably connected to the top inner wall of the collection groove 33, wherein the driven shaft 15 is provided with a driven bevel gear 16 meshed with the driving bevel gear 17, and a lower tail end of the driven shaft 15 is provided with a turbine 52 located in the collection groove 33, wherein the driven shaft 15 is provided with a clamping groove 51 located on an upper side of the turbine 52, and a dust collecting pipe 47 is arranged in the collection groove 33, wherein a dust collection cavity 48 which is intercommunicated is arranged in the dust collecting pipe 47, wherein clamping rods 50 are symmetrically arranged on and in threaded connection with the dust collection cavity 48, wherein the clamping rods 50 are connected with abutted against the clamping groove 51, and turnable handles 49 are arranged on first sides of the clamping rods 50, and a filter screen 79 is fixedly connected with and arranged in the dust collection cavity 48, wherein a convey pipe 80 which is located at a lower end of the filter screen 79 and communicated with an external space is arranged in the dust collection cavity 48, and track blocks 46 symmetrically and fixedly arranged on two end faces of the dust collection cavity 48; wherein the containing claw components 904 comprise pick-up rods 56 in the limiting sliding chutes 36, wherein return springs 64 are connected with and arranged between the pick-up rods 56 and the limiting sliding chutes 36, and upper tail ends of the pick-up rods 56 are fixedly connected to suspension plates 21 which are slidably connected to the slideways 14, and lower tail ends of the pick-up rods 56 are connected to lower pressing plates 55, and extrusion grooves 53 are arranged on the pick-up rods 56, wherein lifting blocks 44 are arranged in and slidably connected with the extrusion grooves 53, wherein compression springs 43 are connected with and arranged between lower sides of the lifting blocks 44 and bottom inner walls of the extrusion grooves 53, and inner sides of the lifting blocks 44 are fixedly connected with lifting rods 45 abutted against the track blocks 46, wherein lower ends of the lifting rods 45 are fixedly connected to upper pressing plates 54.

Beneficially, the vibration switch components 905 comprise inclined sliding blocks 35 in the collection groove 33, wherein pull boxes 37 are symmetrically arranged on the inclined sliding blocks 35, and abutting wheels 41 are arranged on sides, close to the detachable suction component 903, of the pulling boxes 37, and the pull boxes 37 are internally provided with limiting cavities 40, wherein top inner walls of the limiting cavities 40 are provided with and communicated with sliding chutes 38, wherein sliding rods 34 extending up and down into the transmission cavity 11 are arranged on and slidably connected with the sliding chutes 38, wherein the sliding rods 34 are slidably connected to a bottom inner wall of the transmission cavity 11, and restrain springs 58 are connected with and arranged between the sliding rods 34 and the sliding chutes 38, and lower ends of the sliding rods 34 are provided with limiting plates 39 which are located in and slidably connected with the limiting cavities 40, and upper ends of the sliding rods 34 are fixedly connected with abutting plates 31 which are configured to abut against the cams 22, wherein stop springs 32 are connected with and arranged between lower sides of the abutting plates 31 and the bottom inner wall of the transmission cavity 11; wherein the vibration components 906 comprise tracks 62 connected with the collection groove 33, wherein extension plates 57 are connected with the sides, away from the detachable suction component 903, of the tracks 62, wherein power storage springs 63 are arranged between the extension plates 57 and the collection groove 33, and lower tail ends of the lower end of the extension plates 57 are fixedly connected to vibration blocks 42, wherein a film-making component 907 is arranged in one of the vibration blocks 42 at a first side, and rotating rods 59 which are configured to abut against the abutting wheels 41 are rotatably connected to sides, away from the detachable suction component 903, of the extension plates 57, wherein restrain plates 61 on on upper ends of the rotating rods 59 are fixedly connected with the extension plates 57, and tension springs 60 are connected with and arranged between upper sides of the rotating rods 59 and lower sides of the restrain plates 61.

Beneficially, the film-making component 907 comprises an open groove 70 arranged in one of the vibration blocks 42, and a hidden groove 71 is arranged in the one of the vibration blocks 42, wherein a top inner wall of the hidden groove 71 is connected with a tandem shaft 74, wherein a lower end of the tandem shaft 74 is connected to a contact plate 75, wherein a limiting spring 73 is connected with and arranged between an upper side of the contact plate 75 and the top inner wall of the hidden groove 71, and an upper tail end of the tandem shaft 74 is provided with a tandem bevel gear 68 located in the open groove 70, and a worm 72 located at a lower end of the tandem bevel gear 68 is arranged on the tandem shaft 74, and a motor 65 is embedded in a first inner wall of the open groove 70, wherein a first end of the motor 65 is in power connection with an output shaft 66, wherein the output shaft 66 is provided with a reversing bevel gear 67 which is configured to mesh with the tandem bevel gear 68, and a fan wheel 69 is arranged on the output shaft 66, and a fixed-point shaft 76 is arranged in and rotatably connected to the open groove 70, wherein the fixed-point shaft 76 is provided with a worm gear 78 connected with the worm 72, and the fixed-point shaft 76 is provided with a film roller 77 located at one end of the worm gear 78; wherein the extension component 901 comprises a tandem frame 25 connected with the first end face of the cover 10, wherein a threaded shaft 29 is connected with the tandem frame 25, wherein the threaded shaft 29 is connected to a right coupling 24 which is configured to abut against the left coupling 23, wherein a slide cavity 30 is arranged in the right coupling 24, and an extension block 28 located on a first side of the tandem frame 25 is in threaded connection with the threaded shaft 29, wherein a handle 27 is rotatably connected to a first end face of the extension block 28, and a push rod 26 located at an upper end of the threaded shaft 29 is slidably connected to the tandem frame 25, wherein the push rod 26 extends into and is slidably connected to the slide cavity 30.

During operation, the electric motor 20 is started to rotate the upper bevel gear 18 through the transmission shaft 19, and the upper bevel gear 18 sequentially enables the driving bevel gear 17 and the driven bevel gear 16 to rotate, and the driving bevel gear 17 enables the cams 22 and the translation blocks 13 to rotate by means of the drive shaft 12, and the cams 22 push the abutting plates 31 to drive the sliding rods 34 to move upwards, and the pull boxes 37 are driven to move upwards by the sliding rods 34, and then the pull boxes 37 lift the rotating rods 59 by means of the abutting wheels 41 to abut against the restrain plates 61, and then the extension plates 57 and the vibration blocks 42 are driven to move upwards, and at the same time, the power storage springs 63 store power potential energy, and relative to the sliding rods 34, the pull boxes 37 move to directions away from the detachable suction component 903, and the abutting wheels 41 are driven to separated from abutting with the rotating rods 59, and due to elastic recovery of the power storage springs 63 and action of gravity, the vibration blocks 42 are dropped to pound against surfaces to be cleaned so that dust and mites are removed, and at this time, the tandem shaft 74 abuts against the cleaning surfaces to move upwards, so that the worm 72 is connected to the worm gear 78 and the reversing bevel gear 67 is engaged with the tandem bevel gear 68, and the motor 65 is started, and the reversing bevel gear 67 and the fan wheel 69 are rotated by means of the output shaft 66, and the reversing bevel gear 67 drives the tandem bevel gear 68 to rotate by means of engagement connection, and then the worm 72 is driven by the tandem shaft 74 to rotate, and the worm 72 drives the fixed-point shaft 76 to rotated by means of the worm gear 78 so that the film roller 77 outputs films, and at the same time, the fan wheel 69 blows the films to expand to abut against another one of the vibration blocks 42 on a second side, and at this time, the translation blocks 13 move towards each other by means of a threaded connection, and the translation blocks 13 are moved by means of the suspension plates 21 and the pick-up rods 56, and the translation blocks 13 are moved downwards by means of abutting connection of the lifting rods 45 and the track blocks 46, so that the upper pressing plates 54 and the lower pressing plates 55 are clamp to cut off the films and the the films are moved to a lower end of the dust collecting pipe 47, and then the driven bevel gear 16 drives the turbine 52 to rotate by means of the driven shaft 15, so that the films are sucked into the dust collection cavity 48 due to the air pressure difference, and then the films are conveyed through the convey pipe 80 into an externally connected dustbin; when the extension component 901 is needed to be extended, the push rod 26 is pushed to drive the right coupling 24 to abut against the left coupling 23 to drive the threaded shaft 29 to rotate, and the threaded shaft 29 enables the extension block 28 to move to the second side by means of threaded connection; after operation is finished, the turnable handles 49 are rotated to drive the clamping rods 50 to separate from the clamping groove 51, and the dust collecting pipe 47 is taken down, and then the filter screen 79 is cleaned to ensure inner walls of the present invention is clean during the next use.

The benefits of the invention are as follows:

The present invention has a simple structure and is convenient to operate. Mites and dust adsorbed can be sufficiently removed from the member to be clean in the form of knocking and vibrating. And in this way, the cleaning quality is improved compared with traditional brush-type cleaning method.

In the above manner, those skilled in the art can make various changes according to working modes within the scope of the present invention.

1. A mites-removing cleaning brush for automobile, comprising:
a cover;
an extension component connected with a first end face of the cover,
wherein the extension component is used when a human arm cannot extend into a certain area;
a transmission cavity arranged in the cover;
a power linkage component is arranged in the transmission cavity,
wherein the extension component is controlled by the power linkage component;
a collection groove in a lower end of the transmission cavity arranged in the cover;
a detachable suction component rotatably connected with a top inner wall of the collection groove;
limiting sliding chutes, which is located on two ends of the detachable suction component, symmetrically arranged on and communicated with the top inner wall of the collection groove;
containing claw components slidably connected with and arranged in the limiting sliding chutes;
vibration switch components, which are symmetric and located in the limiting sliding chutes, slidably connected with the top inner wall of the collection groove;
vibration components symmetrically arranged on the top inner wall of the collection groove,
wherein each of the vibration components is located on one side of a respective one of the vibration switch components.

2. The mites-removing cleaning brush for automobile according to claim 1, wherein the power linkage component comprises a drive shaft at an outer side of a first end of the transmission cavity,
wherein a first tail end the drive shaft is provided with a left coupling, and cams are symmetrically arranged on the drive shaft,
wherein translation blocks which are symmetric are in threaded connection with the drive shaft,
wherein the translation blocks are provided with slideways, and a driving bevel gear is arranged on the drive shaft, and an electric motor is embedded in a top inner wall of the transmission cavity,
wherein a lower tail end of the electric motor is in power connection with a transmission shaft extending up and down,
wherein the transmission shaft is provided with an upper bevel gear meshed with the driving bevel gear.

3. The mites-removing cleaning brush for automobile according to claim 1, wherein the detachable suction component comprises a driven shaft rotatably connected to the top inner wall of the collection groove,
wherein the driven shaft is provided with a driven bevel gear meshed with the driving bevel gear, and a lower tail end of the driven shaft is provided with a turbine located in the collection groove,
wherein the driven shaft is provided with a clamping groove located on an upper side of the turbine, and a dust collecting pipe is arranged in the collection groove,
wherein a dust collection cavity which is intercommunicated is arranged in the dust collecting pipe,
wherein clamping rods are symmetrically arranged on and in threaded connection with the dust collection cavity,
wherein the clamping rods are connected with abutted against the clamping groove, and turnable handles are arranged on first sides of the clamping rods, and a filter screen is fixedly connected with and arranged in the dust collection cavity,
wherein a convey pipe which is located at a lower end of the filter screen and communicated with an external space is arranged in the dust collection cavity, and track blocks symmetrically and fixedly arranged on two end faces of the dust collection cavity;
wherein the containing claw components comprise pick-up rods in the limiting sliding chutes,
wherein return springs are connected with and arranged between the pick-up rods and the limiting sliding chutes, and upper tail ends of the pick-up rods are fixedly connected to suspension plates which are slidably connected to the slideways, and lower tail ends of the pick-up rods are connected to lower pressing plates, and extrusion grooves are arranged on the pick-up rods,
wherein lifting blocks are arranged in and slidably connected with the extrusion grooves,
wherein compression springs are connected with and arranged between lower sides of the lifting blocks and bottom inner walls of the extrusion grooves, and inner sides of the lifting blocks are fixedly connected with lifting rods abutted against the track blocks,
wherein lower ends of the lifting rods are fixedly connected to upper pressing plates.

4. The mites-removing cleaning brush for automobile according to claim 1, wherein the vibration switch components comprise inclined sliding blocks in the collection groove,
wherein pull boxes are symmetrically arranged on the inclined sliding blocks, and abutting wheels are arranged on sides, close to the detachable suction component, of the pulling boxes, and the pull boxes are internally provided with limiting cavities,
wherein top inner walls of the limiting cavities are provided with and communicated with sliding chutes,
wherein sliding rods extending up and down into the transmission cavity are arranged on and slidably connected with the sliding chutes,
wherein the sliding rods are slidably connected to a bottom inner wall of the transmission cavity, and restrain springs are connected with and arranged between the sliding rods and the sliding chutes, and lower ends of the sliding rods are provided with limiting plates which are located in and slidably connected with the limiting cavities, and upper ends of the sliding rods are fixedly connected with abutting plates which are configured to abut against the cams, wherein stop springs are connected with and arranged between lower sides of the abutting plates and the bottom inner wall of the transmission cavity;
wherein the vibration components comprise tracks connected with the collection groove, wherein extension plates are connected with the sides, away from the detachable suction component, of the tracks,
wherein power storage springs are arranged between the extension plates and the collection groove, and lower tail ends of the lower end of the extension plates are fixedly connected to vibration blocks,
wherein a film-making component is arranged in one of the vibration blocks at a first side, and rotating rods which are configured to abut against the abutting wheels are rotatably connected to sides, away from the detachable suction component, of the extension plates,
wherein restrain plates on on upper ends of the rotating rods are fixedly connected with the extension plates, and tension springs are connected with and arranged between upper sides of the rotating rods and lower sides of the restrain plates.

5. The mites-removing cleaning brush for automobile according to claim 1, wherein the film-making component comprises an open groove arranged in one of the vibration blocks, and a hidden groove is arranged in the one of the vibration blocks,
wherein a top inner wall of the hidden groove is connected with a tandem shaft,
wherein a lower end of the tandem shaft is connected to a contact plate,
wherein a limiting spring is connected with and arranged between an upper side of the contact plate and the top inner wall of the hidden groove, and an upper tail end of the tandem shaft is provided with a tandem bevel gear located in the open groove, and a worm located at a lower end of the tandem bevel gear is arranged on the tandem shaft, and a motor is embedded in a first inner wall of the open groove,
wherein a first end of the motor is in power connection with an output shaft,
wherein the output shaft is provided with a reversing bevel gear which is configured to mesh with the tandem bevel gear, and a fan wheel is arranged on the output shaft, and a fixed-point shaft is arranged in and rotatably connected to the open groove,
wherein the fixed-point shaft is provided with a worm gear connected with the worm, and the fixed-point shaft is provided with a film roller located at one end of the worm gear;
wherein the extension component comprises a tandem frame connected with the first end face of the cover,
wherein a threaded shaft is connected with the tandem frame,
wherein the threaded shaft is connected to a right coupling which is configured to abut against the left coupling,
wherein a slide cavity is arranged in the right coupling, and an extension block located on a first side of the tandem frame is in threaded connection with the threaded shaft,
wherein a handle is rotatably connected to a first end face of the extension block, and a push rod located at an upper end of the threaded shaft is slidably connected to the tandem frame,
wherein the push rod extends into and is slidably connected to the slide cavity.
